(19) United States
(12) Patent Application Publication
(10) Pub. No.: US 2003/0004893 A1
(43) Pub. Date: Jan. 2, 2003

(54) System and method for the distribution of mail items

(76) Inventor: Dietrich Blaesche, Singen (DE)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/216,996

(22) Filed: Aug. 12, 2002

Related U.S. Application Data
(63) Continuation of application No. PCT/DE01/00474, filed on Feb. 7, 2001.

(30) Foreign Application Priority Data
Feb. 21, 2000 (DE) 100 07 897.4

(51) Int. Cl. G06F 17/60

(52) U.S. Cl. 705/64

(57) ABSTRACT

A system and method is set out for the distribution of mail parcels and in particular a controlled forwarding of mail parcels. Within the mail stream process, additional steps are introduced as a form of a special service to a customer. Upon request, parcels intended for a particular address maybe withdrawn from the mail stream and scanned. The scanning may be limited to the address information on a surface of the parcel. Alternatively, the scanning may extend further into the parcel itself and/or comprise information about the parcel such as addresser, condition of parcel and the like. The scanned information is processed and forwarded to the customer who is then provided with the option of advance notice to select information about the parcel. Such select information may be used by the customer in providing prior approval for the forwarding of the parcel to a customer select address.

### CROSS REFERENCE TO RELATED APPLICATIONS

This application is a continuation of and claims priority to International Application No.: PCT/DE01/00474 which was filed Feb. 7, 2001 and designated the United States. This application claims priority to German application 10007897.4 filed Feb. 21, 2000.

### BACKGROUND OF THE INVENTION

The present invention relates to the field of parcel distribution and more particularly to a method for prescreening mail pieces or parcels distributed by a postal system. Current postal distribution systems include two major sorting stations. A first is located proximate to the parcel sender, The second is located proximate to the parcel receiver, At the first station, heretofore referred to as the incoming station, parcels are scanned and sorted for distribution to the second, heretofore district station. The district station is determined by electronically reading the destination address and associating it to the proximate district station. At the district station, the parcel is sorted again, by destination address, and associated with the appropriate mail carrier for manual delivery.

Most postal systems offer their customers the opportunity to forward mail to another address. For example, should a mail recipient relocate, either permanently or temporarily, his or her mail may be rerouted accordingly, so that continuous mail delivery service can be maintained. The forwarding of parcels, although primarily a manual endeavor, is not without its problems. For example, forwarded parcels still must be sorted and routed to the district station, and from their, resorted and rerouted again to the district station associated with the forwarding address.

One procedure for forwarding mail at the district level is as follows. During normal operation, the letter carrier sorts parcels into bins associated with addresses along his or her route. Should a forwarding request exist for one of his or her addresses, the carrier will receive a forwarding label with the new address. A forwarding card or marker is placed in the bin associated with the address effected by the forwarding request. And parcels, normally slated for that bin, now receive a new hand written address from the mail carrier. Parcels with the forwarded address hand written thereon, are then returned into the postal system and rerouted accordingly. This process includes several disadvantages, including time delay in having a parcel sorted and routed all the way to the local level and relying upon the mail carrier to manually redirect the parcel. Where mail carriers are overworked or understaffed, such rerouting may not take high priority thereby adding to the already elongated route of travel of the forwarded parcel to its proper destination.

Another procedure has the letter carrier identifying parcels to be forwarded; withdrawing the parcels from the mailstream; and forwarding the parcels to a central processing center for forwarding. With the help of extraction techniques, staff at the central processing center enter the invalid, old or former address into a computer. The computer is networked to a central database. The database contains information about all change of address and/or forwarding requests. The database is queried to display a list of new addresses and names of persons who placed forwarding orders. Staff search the list for a match to the name indicated on the parcel to be forwarded. When a match is made, a new label with the new address is either automatically or manually applied to the parcel to be forwarded. The new label covers up at least the bar code printed on the parcel when it first entered the mailstream, essentially replacing the bar code with one for the new address. Accordingly, the letter can be read and coded automatically with other parcels in the mail stream. This process has several disadvantages, including expenditure of labor and resources in locating and applying the new label as well as pulling parcels to be forwarded from the mail stream. As a result delays and unnecessary rerouting occur.

Another procedure makes use of optical character recognition (OCR) technology. Herein, mail pieces to be forwarded are intercepted by the letter carrier, provided with stamps that may read “Relocated, address unknown” and sent to an automatic forwarding center. The mail forwarding center is equipped with optical scanning equipment which automatically read the sender and receiver's address on the parcel to be forwarded, A database, having forwarding information, is automatically queried and the appropriate address determined. In addition to forwarding addresses, other information may be obtained from the database, including: mailing remarks; advance orders, and other comments. Analysis of data in the database assists in the decision as to how to further treat the mail piece to be forwarded. In an additional automatic step, a label with the new address is applied on the mail piece to be forwarded. A bar code is printed thereon and the mail piece is re-integrated into the regular stream of letters for delivery. This procedure also suffers from the disadvantages discussed above.

U.S. Pat. No. 5,422,821 discloses a system for the forwarding of incorrectly addressed parcels. The parcels are scanned early in the sorting process and a distinction is made between machine readable and illegible addresses. Machine readable addresses are compared with a list of forwarding addresses in a national database. Where a match is found, a new zip code is applied to the parcel and it is rerouted accordingly. Illegible addresses are scanned and a digital image is made and saved into memory. The image is then manually processed for appropriate forwarding.

### BRIEF SUMMARY OF THE INVENTION

The present invention is directed to a system and method for speeding up the forwarding of parcels while offering customers additional services and options. An additional advantage includes the lowering of costs for transporting and sorting parcels. Still another advantage is providing mail services with an additional service from which to generate revenue. These and other advantages are made available by the present invention wherein parcels subject to a forwarding request or related service request are scanned and stored in a particular password (and consecutive number in the overall customer forwarding requesters scheme) protected memory address along with a record of the request. The parcels are held in a holding station rather than being farther sorted in the mailstream, The customer is notified that parcels have been scanned. The customer may then remotely access the memory address and view images of the parcels (via password and number), and based on that viewed, order that some or all viewed parcels in fact be forwarded or disposed.

A further feature includes the opening of the parcel, scanning of its contents and making images of the contents available to the customer for prior forwarding approval. Upon such approval, the parcels are either resealed or placed in new accommodations and appropriately forwarded.

A further feature of the present invention includes obtaining other information about the parcel in advance of delivery, such as addressee data, type and condition of parcel, size, weight and the like. Likewise, the character of the parcel, such as express or registered mail, may be known in advance. Herein, the customer is provided with advance notice that additional steps in receiving the parcel in question are required.

A further feature of the present invention includes alternative modes of communication, including electronic communication with mobile devices. Such communication may include e-mail, SMS and the like to personal computers, mobile telephones, personal digital assistants and the like. This feature adds a degree of mobility for customers who may be traveling and such.

Accordingly, by the present system and method, the customer is provided with advance notice of mail to be received and/or forwarded such that advance decisions on delivery can be made. Likewise, the mail system is provided with an additional service from which to generate revenue, as well as a more efficient and reduced load mail stream to process.

### BRIEF DESCRIPTION OF THE SEVERAL VIEWS OF THE DRAWINGS

The novel features and method steps believed characteristic of the invention are set out in the claims below. The invention itself, however, as well as other features and advantages thereof, are best understood by reference to the detailed description, which follows, when read in conjunction with the accompanying drawings, wherein:

FIG. 1 depicts a schematic overview of a first portion of the instant method;

FIG. 2 depicts a schematic overview of a second portion of the instant method:

FIG. 3 depicts a schematic overview of a third portion of the instant method; and

FIGS. 4a and 4b depict a flow chart of procedure steps.

### DETAILED DESCRIPTION OF THE INVENTION

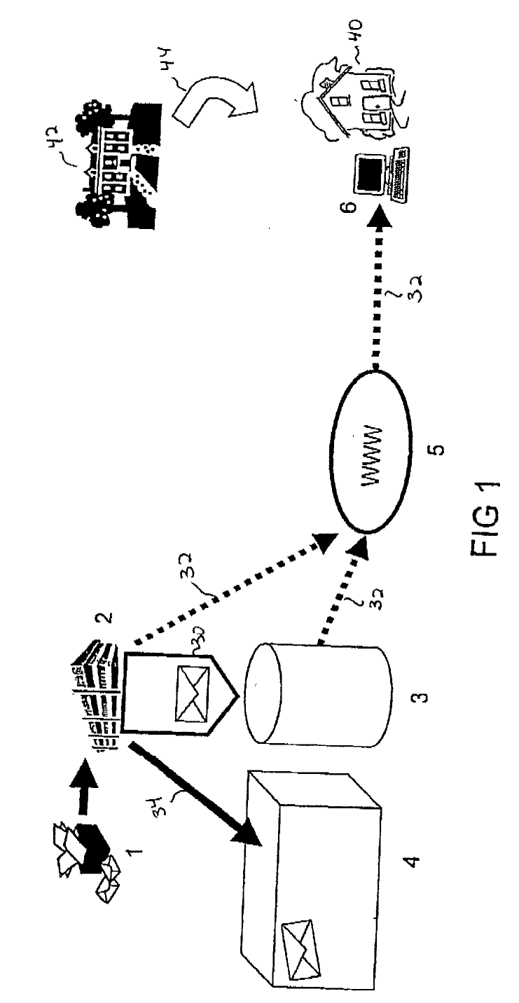

With reference to FIGS. 1-3 generally and FIG. 1 in particular, parcels 1 are first introduced into a mail stream by a sender (not shown) at an inbound sorting station 2. Herein, the address surface of the parcels, and recipient address in particular, are scanned and read with optical scanning or video imaging equipment having OCR and/or other appropriate decoding means. The decoded digital image is stored into a local or remote memory by appropriate processing means 30. The memory, processor and configuration thereof for remote access and multiple users is a design choice known to one skilled in the computer arts. Given the location flexibility of networked computers, the memory and processor may be located at the inbound station, holding station 4, or other location accessible to mail sorting staff. Should a parcel address not be machine readable, alternative means are employed such as manually reading the parcel destination address.

After a parcel destination address is determined database 3 is queried for a matching address. Database 3 contains a list of all destination addresses from which a forwarding request or other special instructions was received. Special instructions may include preview of parcel contents; parcel characteristics (mail deliver service such as registered, courier, etc.); parcel dimensions; parcel condition; addressee data; and the like. In addition, the customers prior approval of forwarding the parcel or information related thereto may be sought. Entries in the database may comprise any format provided the intent of the request and appropriate supporting data is present. For example, rerouting requests may comprise recipient name, old and new address and effective time frame. The rerouting requests may be password and consecutive number protected and remotely (i.e. customer) accessible. In addition, supporting equipment at the location of scanning are present to execute special instructions. For example, where the customer requests that the contents of the parcels be scanned and forwarded for review and what not, parcel opening and resealing equipment and the like. Where parcels cannot be resealed, contents are placed into new parcels.

When a match is found, the parcel is routed 34 to holding station 4; the requests are retrieved and executed; the scanned image and any other relevant information (pursuant to the special instructions) are stored in the memory address associated with the customer 6; and the customer is notified. Such notification may be in electronic form 32 and occur over the world wide web 5 or other appropriate means. The electronic form may comprise e-mail, SMS and the like and is effected by means known to one skilled in the communications art. The message may comprise the number of items to be forwarded as well as other mail piece specific information including weight, size, addresser, and content. Likewise, the actual image itself my be communicated to the customer. This is especially helpful when the addressee data is incomplete or otherwise suspect. If numerous mailpieces are present, the information associated therewith may be cataloged via sequential numbers and the like. Alternatively, rather than communicating the message to the customer, the customer may be provided with queued or unqueued access to the forwarding database 3. Such access may be password and number controlled, on an account basis, and the like. As depicted in the figures a customer's new address 40 is different from customer old address 42. However, this may not need be the case when a customer desires to simply preview and have approval control over his or her post, Instructions, generally, are depicted by arrow 44.

Where no match is found, parcels are routed through the mail stream per normal operations.

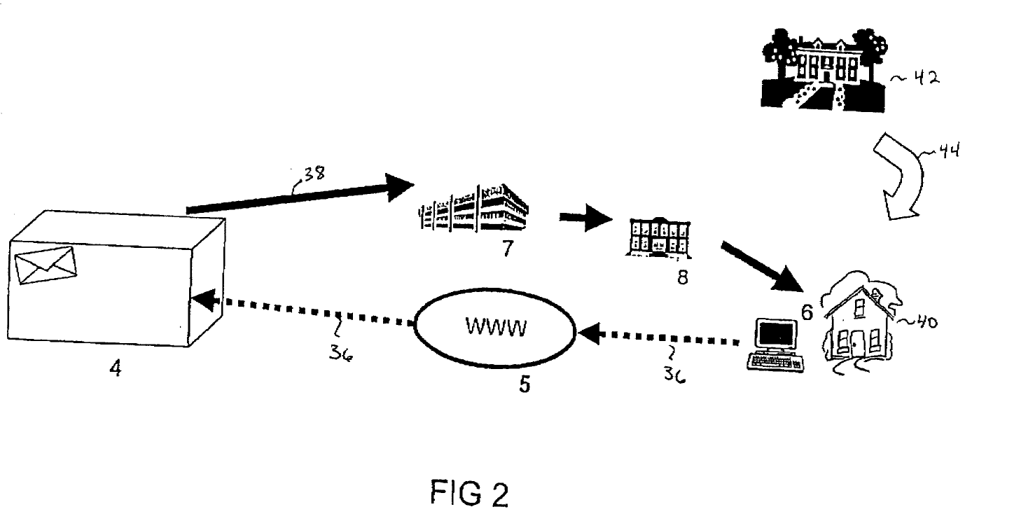

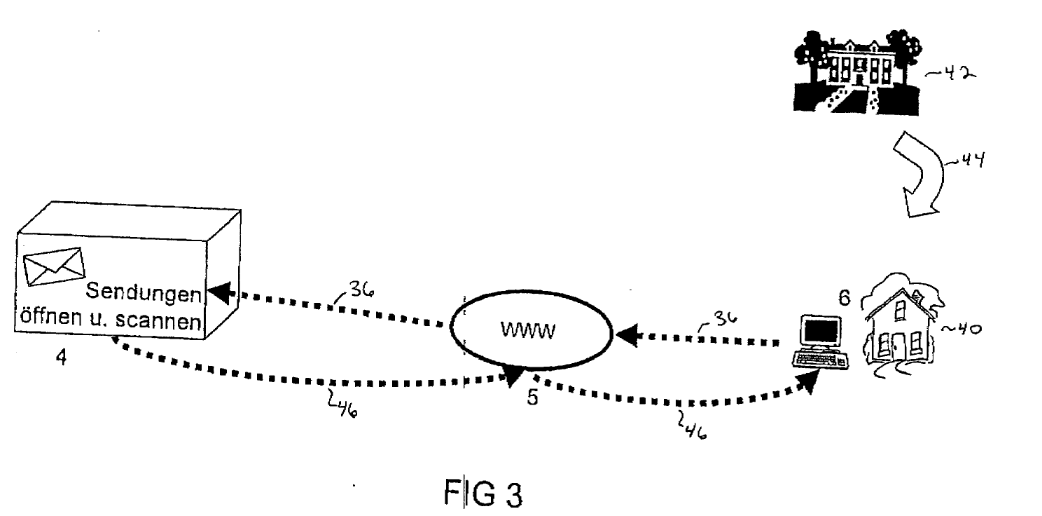

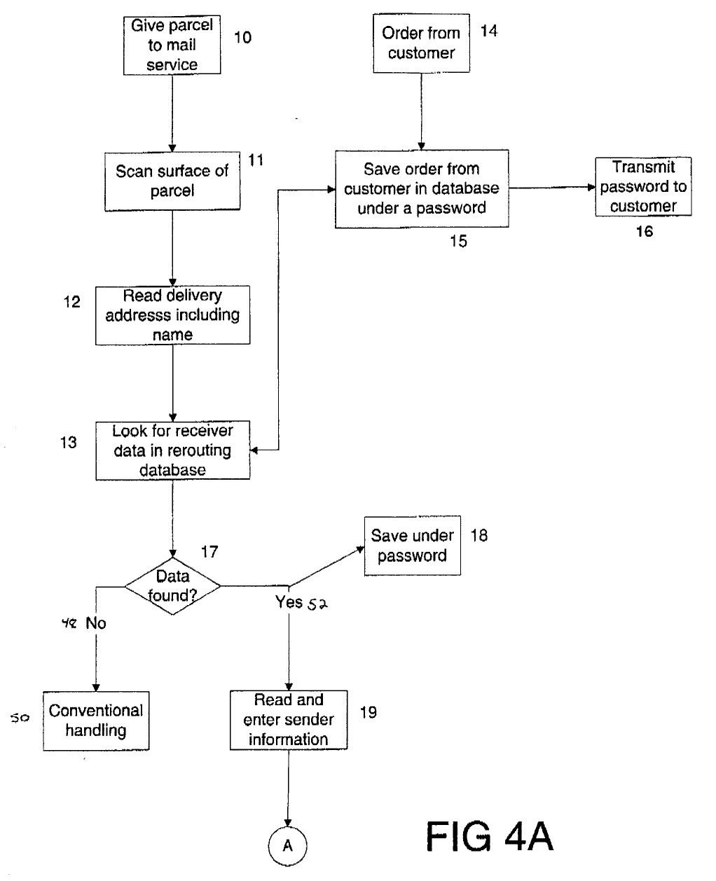

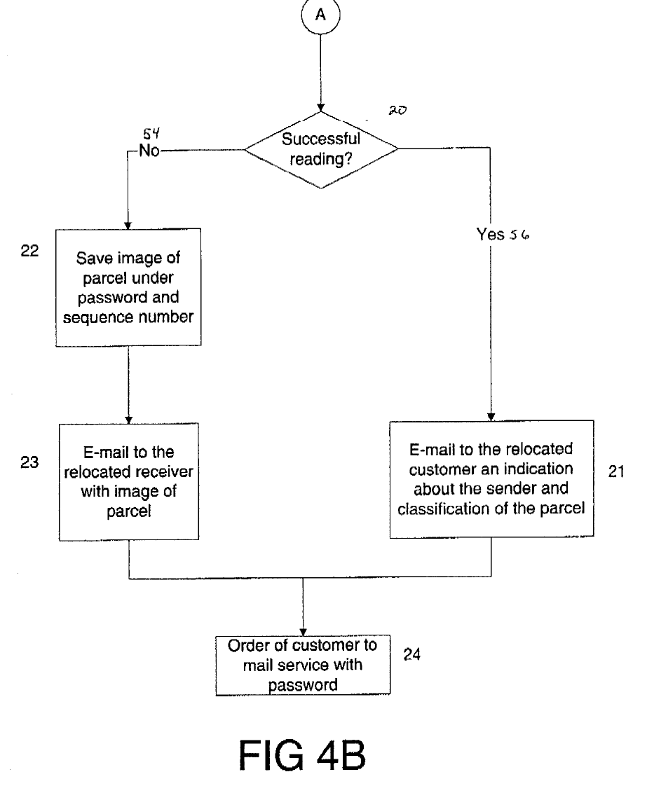

Referring to FIG. 2, the customer provides his or her feedback regarding the images of the parcels being held for him or her at holding station 4, The feedback may also be communicated electronically as discussed above. Where approval for forwarding the parcels is not provided, the parcels are discarded. Where approval is given, the parcels are routed 38, per instructions in database 3, as previously provided by the customer. Herein, the parcels are routed to a district sorting center 7, locally sorted into appropriate bins 8, and eventually routed to the customer's new address 40. Referring to FIG. 3, the customer provided approval for the communicating of images of the contents of the parcels 36 and the images are communicated back 46 electronically. This adds a degree of mobility to the customer, who is now only bound to an electronic message receiving device. Referring to FIGS. 4a and 4b, a flow chart of the above described procedure is set out. The parcel is introduced into the mail stream 10. The address surface of the parcel is scanned 11. The destination address is decoded 12. A database is searched for matches to the decoded address 13. A determination 17 is made whether their is a match in the database to the parcel destination address. If no match is found 48, conventional reading methods are employed 50, such as manual inspection. If a match is found 52, the parcel image is saved into the database customer memory address 18 and the customer instructions are retrieved from the database 19. Herein, the flowchart continues in FIG. 4B. At some point prior to the entry of the parcel into the mail stream (step 10), the customer makes a forwarding request and/or submits other special instruction 14. The request is saved into a password and consecutive number protected database memory address 15 and the password and number are forwarded to the customer for future database access 16, Referring to FIG. 4B, a determination is made whether the parcel address was effectively read 20. If the address was not successfully read 54, an image of the parcel destination address is made, if not already made, and saved into the customer database memory address 22. The image is then sent to the customer 23 and the method proceeds to step 24. If the parcel destination address was successfully read 56, it is sent to the customer 21 and the method continues to step 24. In step 24, the customer decides whether to have the parcel forwarded (electronically or physically) or discarded. This may be conveyed by password.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for distributing parcels, comprising the steps of:
generating an image of a parcel face, said face including at least a destination address, and electronically reading said address;
communicating said address to a customer in advance of parcel delivery; and
delivering said parcel to a customer designated address only upon prior approval from said customer.

2. The method according to claim 1, further comprising the steps of:
communicating said image to said customer;
receiving said parcel at a first location;
storing said parcel at a second location; and
wherein said step of forwarding rher comprises the step of forwarding said parcel from said second location to said customer designated address.

3. The method according to claim 2, further comprising the steps of:
receiving forwarding instructions from said customer;
receiving customer information from said customer, said customer information including said designated address and mode of communication;
storing said instructions and information in a database such that said instructions and information are associated with one another for remote retrieval, generating a password and number of the order in which said instructions were received and conveying said password and number to said customer;
storing said image and electronically read address in said database such that said image and electronically read address is associated with said instructions and said information; and
executing said instructions upon customer instruction, said customer instruction being accompanied by said password and number.

4. The method according to claim 3, wherein said mode of communication comprises e-mail.

5. The method according to claim 3, wherein said mode of communication comprises SMS.

6. The method according to claim 3, wherein said instructions comprises the steps of:
opening said parcel;
scanning contents of said parcel; and
storing said contents in said database associated with said instructions.

7. The method according to claim 6, wherein said contents are electronically communicated to said customer.

8. The method according to claim 7, further comprising the steps of:
receiving approval from said customer for forwarding said contents;
placing said contents into an accommodation; and
forwarding said accommodation to said customer designated address.

9. The method according to claim 3, wherein said instructions comprise:
determining characteristics of said parcel; and
storing said characteristics in said database associated with said customer information.

10. The method according to claim 9, wherein said characteristics comprise dimensions of said parcel.

11. The method according to claim 9, wherein said characteristics comprise addresser information.

12. The method according to claim 9, wherein said characteristics comprise physical condition of said parcel.

13. The method according to claim 9, wherein said characteristics comprise a type of mail deliver service.

14. The method according to claim 3, wherein information stored in said database is available to said customer remote access.

15. The method according to claim 1, wherein said communicating is effected electronically.

16. The method according to claim 15, wherein said communicating is effected by e-mail.

17. The method according to claim 15, wherein said communicating is effected by SMS.

18. The method according to claim 15, wherein said communicating is effected by telephone

19. The method according to claim 3, wherein said communicating is made in person.

20. A system for previewing parcels, comprising:
means for generating an image of a parcel address surface and decoding said address,
means for making said image available to a customer in advance of parcel delivery,
means for receiving approval from said customer to forward said parcel, and
when approval has been received, means for forwarding said parcel to a customer selected address.

21. The system according to claim 20, further comprising:
means for receiving instructions from said customer,
means for storing said instructions in a memory address in a database,
means for storing said image in said memory address, and
means for storing said decoded address in said memory address.

22. The system according to claim 21, further comprising:
means for searching and retrieving information from said database,
means for determining a match between said information with said address, when a match is determined, means for retrieving instructions from said database,
means for executing said instructions, and
means for routing said parcel into the normal mail stream when a match is not found.

23. The system according to claim 22, further comprising:
means for discarding said parcel when said approval is not received.

23. The system according to claim 20, wherein said image is available to said customer via password protected remote communication means.

24. The system according to claim 23, further comprising means for alerting said customer that a parcel has been scanned and is available to said customer.

25. The system according to claim 24, wherein said means for alerting said customer further comprises means for making parcel information available to said customer, said parcel information including parcel characteristics and scanned parcel contents.

26. The system according to claim 20, further comprising means for determining if said address was successfully decoded, and if said address was not successfully decoded, means for alerting of unsuccessful read.
